(19) United States
(12) Patent Application Publication
(10) Pub. No.: US 2019/0215181 A1
(43) Pub. Date: Jul. 11, 2019

(54) METHOD OF DEMAND SIDE MANAGEMENT CONTROL FOR ELECTRIC APPLIANCES

(71) Applicant: Yoshio Wynn Kano, Barrington, IL (US)

(72) Inventors: Robert John Alvord, Elmwood Park, IL (US); Yoshio Wynn Kano, Barrington, IL (US)

(73) Assignee: Spitfire Controls Division of SigmaTron international, Elgin, IL (US)

(21) Appl. No.: 15/864,982

(22) Filed: Jan. 8, 2018

(51) Int. Cl. H04L 12/28; G06Q 50/06

(52) U.S. Cl. CPC H04L 12/2818; H04L 2012/2845; H04L 2012/285; G06Q 50/06

(57) ABSTRACT

Appliances that use this inventions method of Demand Side Management will be autonomous and intelligently self-controlled and will learn how to manage their own energy use, change with the seasons, and adapt to changing power profiles, without the need of any external control from the power companies, or the user. All this will be done in the background, saving power, with little, or no noticeable change in performance to the user. This method does away with all the infrastructure and cost associated with prior art methods resulting in a method that is so simple and inexpensive that it can be affordably incorporated into almost any electronic device.

### CROSS REFERENCE TO RELATED APPLICATIONS

This application claims the benefit of U.S. provisional patent application Ser. No. 62/444,891 entitled “Method of Peak Demand Control for Electric Appliances” by Robert John Alvord, filed Jan. 11, 2017, and is a non-provisional utility patent continuation thereof.

### REFERENCES CITED

| | Filing | Publication | | |
|---|---|---|---|---|
| Citing Patent | date | date | Applicant | Title |
| U.S. Pat. No. 7,110,832 | Oct. 23, | Sept 19, | Ghent | Energy Management System for an |
| B2 | 2002 | 2006 | | Appliance |
| U.S. Pat. No. 4,317,049 | Sep. 17, | Feb. 23, 1982 | Schweppe | Frequency Adaptive Power-Energy Re- |
| | 1979 | | | scheduler |
| U.S. Pat. No. 7,010,363 | Jun. 13, | Mar. 7, 2006 | Donnelly | Electrical Appliance Energy Consumption |
| | 2003 | | | control methods and electrical energy |
| | | | | consumption systems |
| U.S. Pat. No. 7,110,832 | Dec. 12, | Oct. 23, 2002 | Donnelly | Electrical Appliance Energy Consumption |
| B2 | 2005 | | | control methods and electrical energy |
| | | | | consumption systems |
| U.S. Pat. No. 8,406,937 | Mar. | Mar. 26, 2013 | Verfuerth | System and Method for Reducing Peak and |
| B2 | 27.2008 | | et al. | Off Peak Electricity Demand By Monitoring, |
| | | | | controlling and Metering High Intensity |
| | | | | Florescent Lighting in a Facility |
| US | Apr. 28, | | Brian M. | System for Reduced Peak Power |
| 2011/0095017 | 2011 | | Steurer, | Consumption by a Cooking Appliance |
| A1 | | | | |
| US 2009/0063257 | Aug. 29, | | Robert | Automatic Peak Demand Controller |
| A1 | 2008 | | Edwin Zak | |

### BACKGROUND OF THE INVENTION

The electric utility companies, in an effort to reduce the burden on their generating plants and distribution network during peak energy use episodes, have come up with a method, to reduce peak demand, by having customers allow the utility company to install wireless shut-off switches on their central air conditioners. These switches allow the power company to remotely control the customer's air conditioners and shut them off during peak demand episodes, via the internet. This method of controlling the demand of the appliance is called “Demand Side Management, or DSM).

The shortcomings of current methods of DSM approach are:
1. An internet connection is required for each appliance. This could enable hacking, which could disrupt the grid.
2. Customer cooperation and participation is required, currently customer participation is low.
3. The customer can override the control.
4. The customer can disconnect the control.
5. Currently, this feature is not widely available for any home appliance, other than central air conditioners.
6. Expensive and complex set up.
7. Currently, power providers in cooperation with AHAM and other industry groups attempting to apply similar techniques to defer and control loads in home other appliance and HVAC applications. The previously mentioned set of problems are encountered.
8. These add-on wireless shut off switches are not compatible with most of the existing electronic controls found in appliances because they are only capable of cutting power to the appliance and not able to selectively cut power to, or reschedule specific loads.
9. This method of control is reactive. The power company reacts to a peak and sends a signal to temporarily shut off selected appliances. There are no proactive measures taken to prevent the peak. There is no ability to anticipate or prepare for a peak.

The present invention is a control designed to serve the same purpose as having Demand Side Management control, but addresses the previously mentioned shortcomings as follows:
1. Does not require an internet connection.
2. Does not require any input from the power plant.
3. No customer set up required.
4. Does not require any active participation from the customer.
5. This stand-alone method learns the trends from the AC line frequency.
6. The present invention can sense a peak demand episode, and adjust the appliances power consumption.
7. The present invention can anticipate and lessen a peak demand episode, by rescheduling high demand functions to off peak periods.
8. Because an internet connection is not necessary, it is improbable that this method could be hacked on a large scale, thus preserving grid security and stability.
9. Due to the low cost, this control is practical for use in a wide range of applications beyond home appliances.
10. It is not necessary for the power plant to actively monitor and remotely control these appliances.
   a. However, an alternate construction of this invention could be configured for remote monitoring, with optional add on communication modules.
   b. The preferred method of communication would be through the use of Short-range communication, such as blue tooth, or NFC (near field communication) via the user's mobile phone, FIG. 1-53, 54, 55. A simple app can be developed to allow the user to control appliances as necessary, to re-schedule peak demand period from winter to summer schedule, and allow reporting back to providers of actual responses used, closing the loop back to providers for billing credits. These methods are more secure and lower cost than a full internet connection. The control reverts to “stand alone” mode, if the consumer does not make a connection over a given amount of time, therefore only intermittent communication is needed.
11. Short-term responses for individual appliances can be accomplished by simple rule enhancing responses, which are beyond the capability of prior art connected appliances.
12. Short-term grid emergency responses can be tracked by ongoing sampling and the use of control chart techniques to capture events that are out of the ordinary and respond as necessary.
13. Stand-alone mode techniques eliminate the need for a real time clock and calendar, thus keeping the control simple and low cost.
14. Low cost approach to meet energy standards, such as “Energy Star”.
15. Response to short-term grid stress based on specific set of rules for each appliance type, enabling more efficiency than the standards required in “Energy Star”.
16. If implemented on a large scale, there will be a significant cost saving for the power companies as this invention will reduce the need to build additional power plants and distribution networks, stabilize the grid, and lessen the occurrence of brown outs and black outs.

### BRIEF SUMMARY OF THE INVENTION

During episodes of high demand, the control can detect a slight reduction in line frequency, which is indicative of this high demand episode, and then reschedule the appliances high demand functions to avoid high demand episodes in the future. By anticipating high demand episodes, the appliance can prepare adequately and adjust its loads as best as possible, to prevent any noticeable reduction in performance. When this invention is incorporated into an appliance, like a refrigerator, compressor operation can be scheduled to avoid the peak. High demand functions, such as making ice, or defrosting, can be deferred until the peak has passed, or ideally rescheduled to occur in the middle of the night when the demand, and the cost of electricity, are the lowest. An example of the considerable potential cost savings of rescheduling, are shown in FIG. 7. This method results in much greater savings that prior art, which only shuts off functions at peaks, rather than reschedule functions to low demand hours, because operating on either side of the peak still results in higher costs versus rescheduling to low demand hours.

This detection is accomplished by monitoring the line frequency over longer periods of time than currently monitored in prior art and relies on techniques of averaging over long periods, for instance 45 minutes, then binning data to create a 24-hour profile of the AC grid. The circuitry required for this new monitoring method is simpler, and therefore lower in cost. This monitoring method may be incorporated into the same control that is operating the appliance, thus reducing cost even more. Prior art uses ASICs and powerful micro controllers to extract data quickly because their methods required fast response for complex and expensive line frequency monitoring methods such as a Phase Locked Loop circuitry, that require extra computing and storage power to support the add-on control module.

The present invention will use the knowledge in the control system to predict when a state change (compressor activation) is imminent. This lowers the burden on the microcontroller's speed and power, so that a general-purpose, low cost micro control can be used. This may require some additional RC filters, edge triggered gates and an increase in memory and storage, but the cost will be negligible.

This invention will be designed as an integral part of the appliances existing microprocessor control, thus not requiring its own power supply or microprocessor and can take advantage of the controls existing load switching circuitry to carry out its energy management duties. This level of control allows the appliance to shut off or reschedule certain loads, but keep the appliance otherwise running. This is not possible with prior art, add-on wireless shut off switches, which are only capable of cutting off power to the appliance.

This method of “Demand Side Management” renders prior art methods obsolete. Appliances that use this control method (of the present invention) will be autonomous and intelligently self-controlled and will learn how to manage their own energy use, change with the seasons, and adapt to changing power profiles, without the need of any external control from the power companies, or the user.

Because of this there are also a great opportunity for savings for the power company because this approach does not need to be controlled or monitored by the power company, therefore they would no longer need to purchase or maintain any infrastructure, no personnel needed to operate, monitor, repair, or install this system, no internet provider expenses, no running of internet wires, no installation of control boxes, no need to encourage customer cooperation.

The present invention is a smart control which will learn, when best to use, or not use power. While this invention is susceptible of embodiment in many different forms, there are shown in the drawings and will be described herein in detail specific embodiments thereof, with the understanding that the present disclosure is to be considered as an exemplification of the principles of the invention and is not intended to limit the invention to the specific embodiments illustrated. Below include, but are not limited to, some examples of possible embodiments:

Refrigerators: the smart control will schedule all defrost, and ice cube making, at night when the price of electricity, and demand, is lowest. Can delay a cooling cycle if it occurs during a peak episode.

Dishwashers: once loaded and started, could default to delay operation until a low demand period, unless otherwise required by the user.

Air Conditioners: Although they need to be run during the day, they can learn to avoid running a cooling cycle during known peak times and/or delay a cooling cycle, relying on thermal inertia to maintain an acceptable temperature during the peak. In anticipation of a peak, the control could run the compressor for an extended amount of time prior to the peak to allow it to “coast” longer, and ride out the peak thus maintaining an acceptable temperature. This could be incorporated into both portable air conditioners and central air conditioners.

Ranges and Ovens: Self Cleaning electric ovens can benefit from the present invention by delaying the self-cleaning function to a low demand period. If a short-term grid event occurs during oven use, the control could momentarily cut power to the heating element for as long as possible without allowing the temperature to drop below a predetermined tolerance, and rely on thermal inertia to maintain the oven temperature until the event has passed.

Battery chargers and maintainers, could also benefit from this invention, and charge as much as possible during low demand periods and virtually turn off during peaks.

Electric water heaters are ideally suited to this method due to their thermal mass, which will allow them to almost always ride out the peaks without running a heating cycle.

Electric furnaces and portable heaters could also benefit from this invention. Since the control will know when peaks usually occur, the control could run an extended heating cycle prior to the peak to allow it to “coast” longer, and ride out the peak thus maintaining an acceptable temperature. If a short-term grid event occurs during oven use, the control could momentarily cut power to the heating element for as long as possible without allowing the temperature to drop below a predetermined tolerance, and rely on thermal inertia to maintain the temperature until the event has passed.

### BRIEF DESCRIPTION OF THE DRAWINGS

FIG. 1 is a block diagram of an exemplification of an appliance control system incorporating the present invention, in this case a refrigerator control.

FIG. 2 is a flow chart of the input hardware circuit.

FIG. 3 is a flow chart of the averaging algorithm, showing how the line frequency is measured and interpreted.

FIG. 4 a flow chart of the present inventions operation in a refrigerator application.

FIG. 5 Block diagram for short term stability and demand response, short term measurement and actions. Example of refrigerator responding to disruptions on the grid.

FIG. 6 is a flow chart showing averaging, binning and peak period determination and actions in an adaptive methodology.

FIG. 7 is a chart showing the typical electricity price variations during the summer. This is an actual snapshot of the hourly electricity demand and real-time energy prices in East Kentucky, from Jul. 13 to Jul. 19, 2013. Notice that the price of electricity on Saturday morning was nearly $0.00/MWh versus Thursday afternoon which was nearly $475.00/MWh. This clearly demonstrates the potential huge cost benefits of this invention.

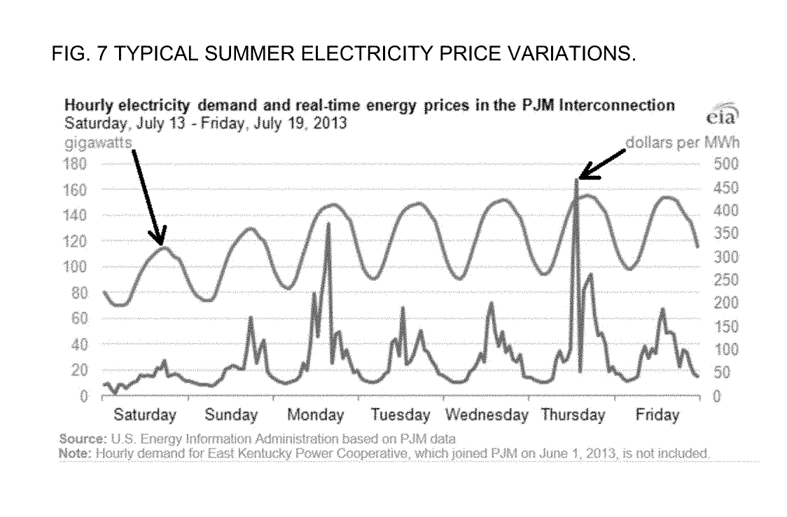

FIG. 8 is a chart showing line frequency variations throughout the day. Excerpt of actual AC line data and averaging algorithm implemented in MS excel. Dotted line is binned data from April 7^{th}, in 32 periods. In this case midnight is at 0 and noon is at 16. The solid line is an average of BINs from previous 8 days.

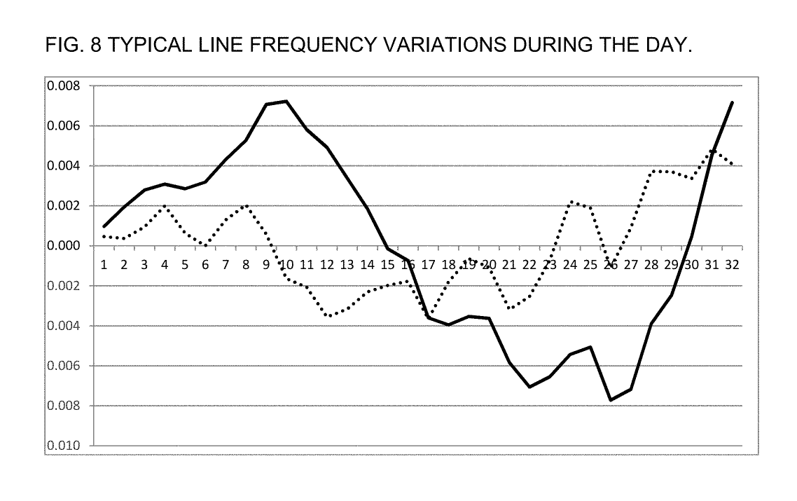

This chart clearly demonstrates that the frequency in the morning is higher when there is less demand and the frequency in the afternoon is lower when there is greater demand. Higher frequencies=lower demand, and lower frequencies=higher demand. A simple algorithm would assign a 4 to 6 hour peak period for each.

FIG. 9 is a chart that shows how easily a short-term grid event can be detected, even though the cause occurred hundreds of miles away. The largest drop occurred on Apr. 7, 2015 and was caused by a generator going down on the east coast (causing the White House to switch to a backup generator), but was captured in the Chicago area. This demonstrates that the use of control chart lines would easily capture an event for action.

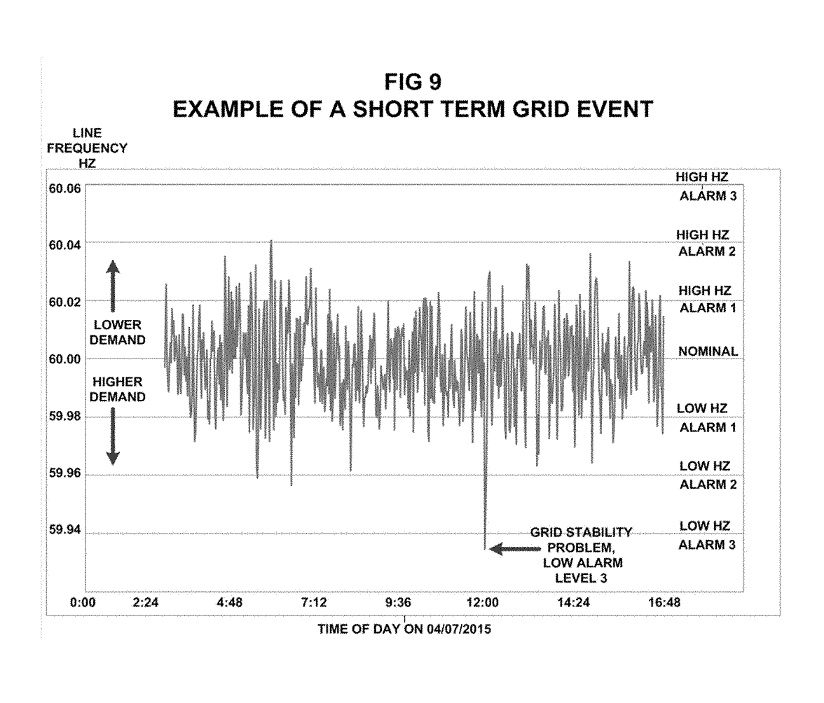

### DETAILED DESCRIPTION OF THE PREFERRED EMBODIMENTS

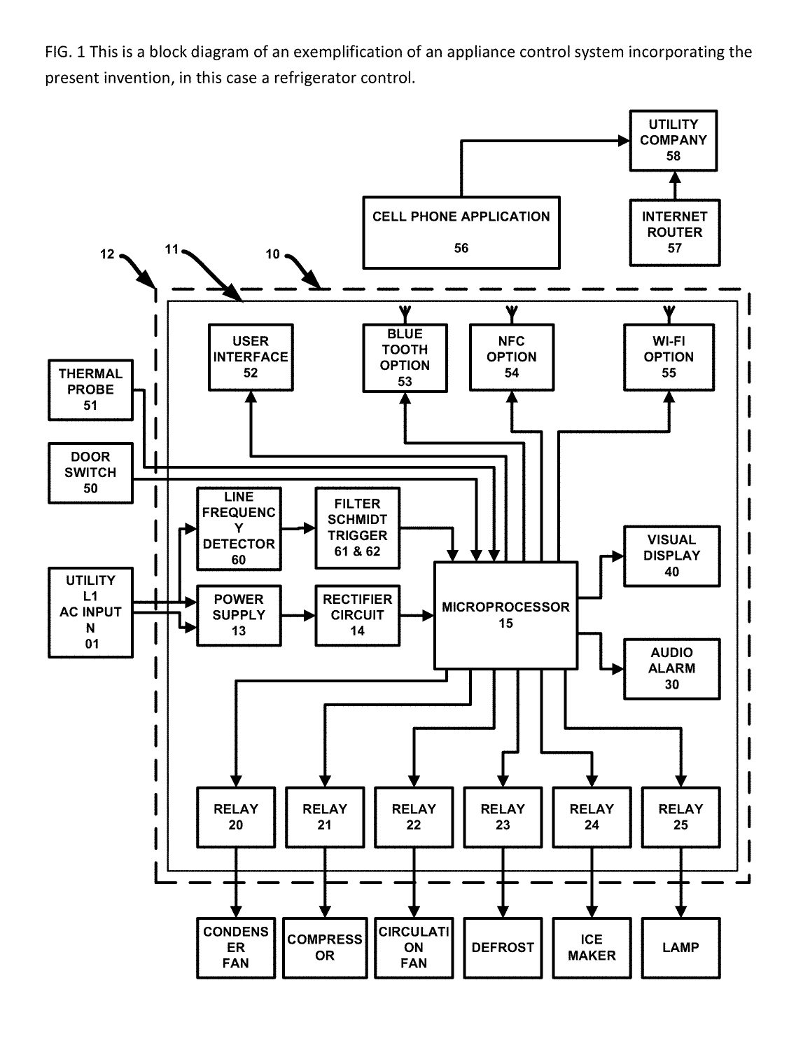

Referring to FIG. 1, an exemplification of an appliance control system incorporating the present invention, in this case a refrigerator control, is indicated generally at 10 and has a printed circuit board 11, which may or may not be mounted in a housing 12 indicated by dashed outline, which has mounted thereon a power supply circuit 13 connected to AC input power lines denoted by L1 and N and provides low voltage power through a rectifier circuit 14 to the microprocessor circuit 15. The microprocessor receives input signals from the door position switch 50, from which it can make decisions on the operation of the lamp 25, and possibly the circulating fan, operation. The input signals from the temperature sensor 51, which may for example be a thermistor, can be used to make decisions about the operation of the compressor 21, and condenser fan 20, in cooling the refrigerator and freezer compartments. The input from the user interface 52, which may be for example, a potentiometer, encoder, or plurality of switches, is used to operate and program the refrigerator. The optional Blue tooth transceiver 53, and near field communication transceiver 54, are both available for communicating with the utility company 58, via a cell phone application 56. The optional Wi-Fi transceiver 55, can provide a full internet connection through a wireless internet router 57, with the utility company 58. Note that these optional communication modules are wholly unnecessary for the normal operation of the appliance, and the function of the present invention. These optional features are provided to be compliant with current prior art methods until these prior art methods are rendered obsolete. When obsolete, the appliance will automatically transition to the new method offered by the present invention. The line frequency detector 60, filter 61, and Schmidt trigger circuits 62, which are configured to receive and process the line frequency which is indicative of the operating state of the associated utility. The microprocessor provides outputs to the load controlling relays 20 thru 25, turning off and on loads as required for the normal operation of the refrigerator and for optimizing power consumption for best economy. The optional audio alarm 30, and a visual display 40, are for indicating the operating state and status of the appliance.

In this exemplification of an appliance control system, the present invention is designed and incorporated into a complete appliance control system that will take over the function of, and replace the existent appliance control in its entirety. This is necessary, in this exemplification, in order to gain full control of all the loads and functions of the appliance. This is also the most economical approach, avoiding the cost of redundant circuitry, hardware, software and interconnection. This will also produce the simplest and most reliable end product.

The operation of this demand managed refrigerator control is as follows: Referring to FIG. 1, AC line voltage is applied to the appliance control power supply 13. The control will operate the refrigerator as any normal refrigerator and energize relays powering the condenser fan 20, compressor 21, circulation fan 22, until the set temperature is achieved.

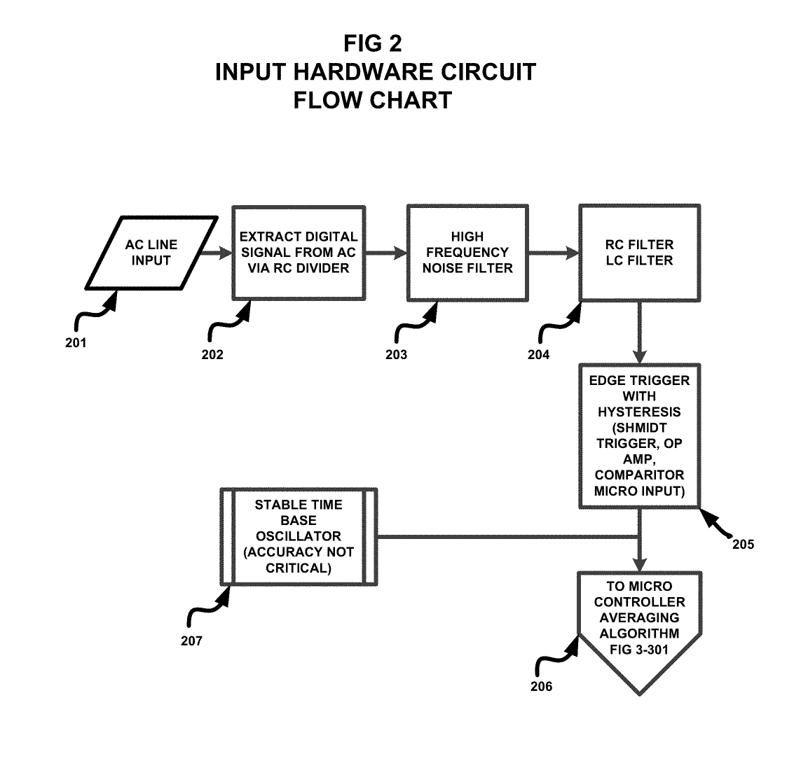

Simultaneously while performing the normal operation of the appliance, the control will start reading the frequency of the power line 201 (refer to FIG. 2) via the line frequency detector 202. This signal is then refined by the filter circuits 203 and 204 and squared up by the Schmidt trigger circuit 205, so the line frequency can be read by the microprocessor 15.

A stable time base 207, is necessary to keep track of when the high and low demand periods occur, however this time base does not have to be synchronized with real time, nor be very accurate, since the target is the middle of the high, or low demand periods, which are generally several hours long, so accuracy down to minutes, or seconds, is not necessary.

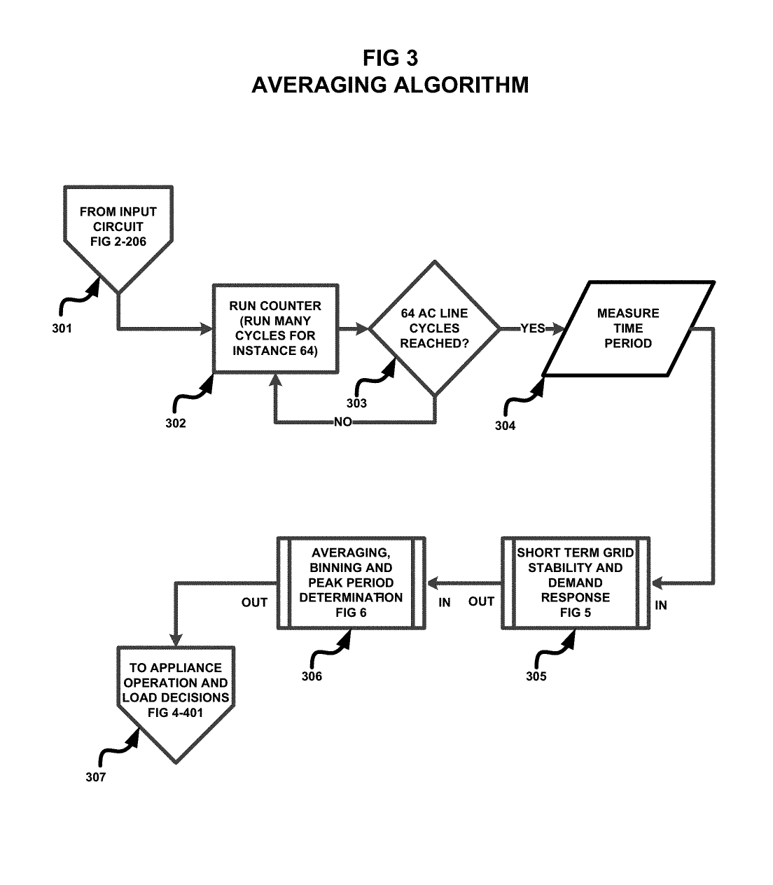

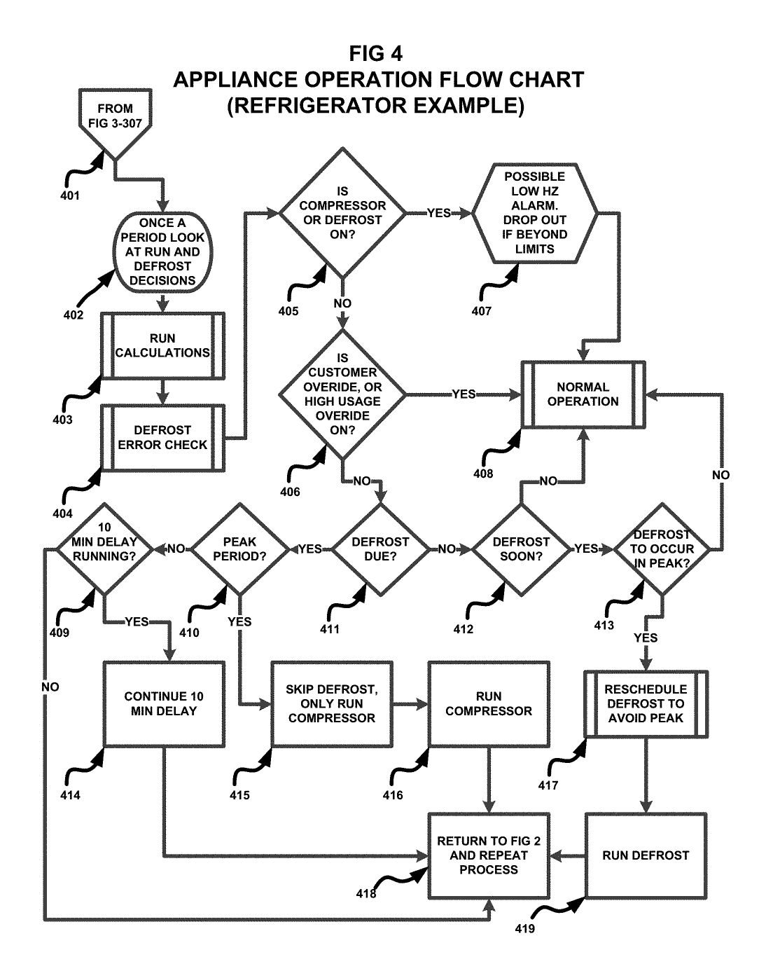

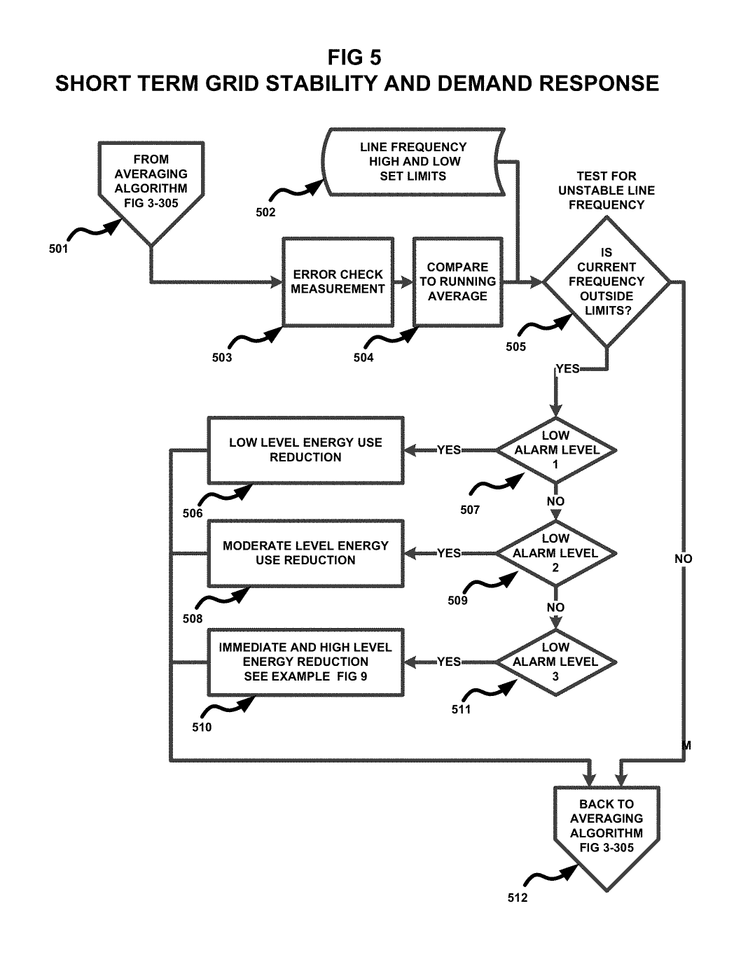

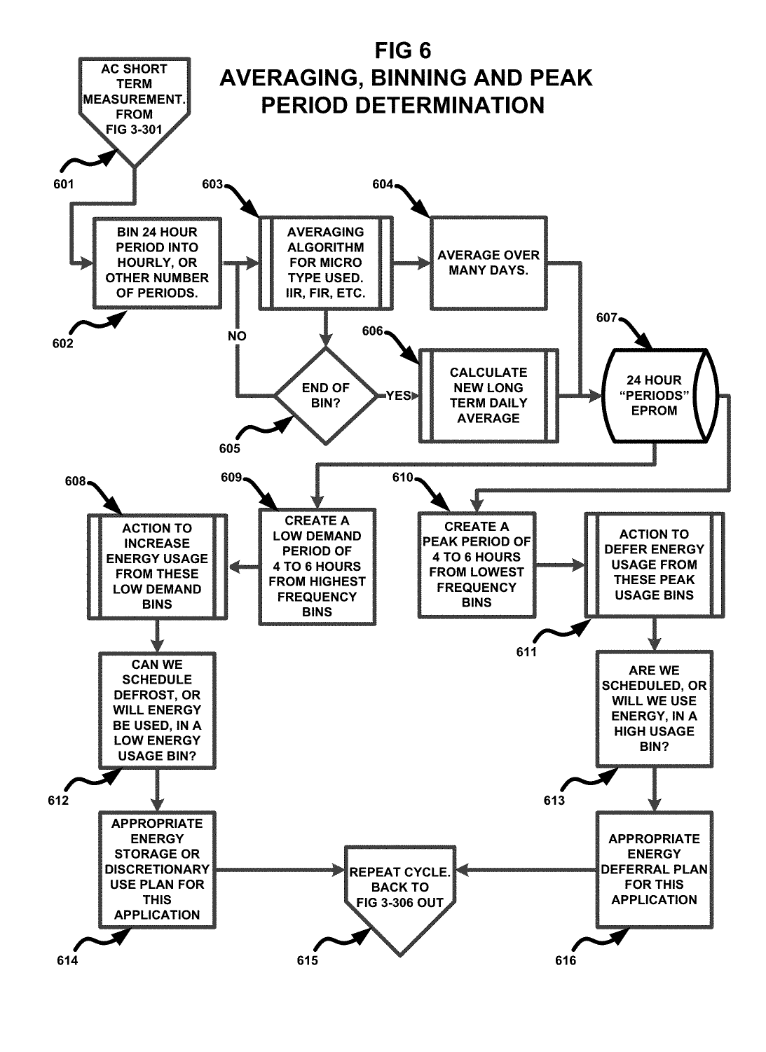

The microprocessor 15, will start processing the information from FIG. 3 301 by counting cycles 302, binning a predetermined amount 303, in this example 64, and measuring the time of each bin 304 and using this data to determine if there is currently a short term grid stability problem requiring immediate response 305, or if not, simply averaging and storing the bins for predicting future high and low demand periods 306, and then continue with the normal operation of the appliance 307. After several days of monitoring the line frequency, enough data will have been recorded in the Microprocessors internal, or external memory, FIG. 6—607, so that now the microprocessor can start making scheduling decisions, an example of which is shown in the flow charts FIGS. 4 and 6, and adjusting loads to ameliorate disruptions in the grid shown in FIG. 5. Some heavy loads are of a low priority, such as defrosting and ice making 417, and can be scheduled to operate only at times of low demand, or shut off entirely if needed 415, 510, as shown in FIGS. 4 and 5.

FIG. 6 is a flow chart showing averaging, binning and peak period determination and actions in an adaptive methodology. The line frequency is continually monitored 601, binned 602, and averaged 603, updated 606 and stored 607. This information is used to continuously update the peak period prediction 610 and the low demand period prediction 609, thus allowing this control to follow power consumption trends, change with the seasons, and adapt to changing power profiles, without the need of any external control from the power companies, or the end user. The control is constantly optimizing its power consumption for optimum economy for the user, as well as for optimum efficiency for the power companies.

What is claimed is:

1. A method of controlling appliances by reducing power consumption during high demand periods, and increasing power consumption during low demand periods, by monitoring the frequency of the power line, and using this information to predict power trends and schedule power use proactively, which will result in lower energy costs for the consumer.

2. The present invention provides all the benefits of prior art Demand Side Management, but at virtually no cost to the power companies, due to its simplicity and lack of the requirement to be remotely controlled and internet connected.

3. Appliances that use this control method will be autonomous and intelligently self-controlled and will learn how to manage their own energy use, change with the seasons, and adapt to changing power profiles, without the need of any external control from the power companies, or the user.

4-18. (canceled)

20. (canceled)
